(19) United States
(12) Patent Application Publication
(10) Pub. No.: US 2019/0087798 A1
(43) Pub. Date: Mar. 21, 2019

(54) SYSTEM FOR DIGITAL TAX VENDING

(71) Applicants: Julian Huascar LOPEZ SANCHEZ, Codigo Postal (DO); Any Micel LOPEZ CASTILLO, Distrito Nacional Codigo Postal (DO); LOSABEC, LLC. /CORPORACION LOSABEC, ESTRATEGIAS GLOBALES SRL, Boulder, CO (US)

(72) Inventors: Any Micel Lopez, Boulder, CO (US); Julian Huascar Lopez, San Francisco (DO); LOSABEC CORPORATION SRL./LLC., BOULDER, CO (US); HUASCAR JOSE LOPEZ, Santo Domingo (DO)

(73) Assignees: ANY MICEL LOPEZ, Boulder, CO (US); Julian Huascar Lopez, Santo Domingo (DO); Cecilia Minerva Castillo, Santo Domingo (DO); Huascar Jose Lopez, Santo Domingo (DO); Shilakshanti Puls, Boulder, CO (US); Marianna Cecilia Lopez, Santo Domingo (DO); Beatriz Micel Sanchez, Boulder, CO (US)

(21) Appl. No.: 15/543,979

(22) PCT Filed: Dec. 8, 2015
(86) PCT No.: PCT/DO2015/000004

§ 371 Date: Nov. 21, 2018

(30) Foreign Application Priority Data
Jan. 14, 2015 (DO) P2015-0010

(51) Int. Cl. G06Q 20/18; G06Q 40/00

(52) U.S. Cl. CPC G06Q 20/18; G06Q 40/123

(57) ABSTRACT

This invention provides an integral system to expedite the collection of all governments' taxes, including judicial tax imprints, service fees, as well as, all state, county, city dues related to all tax fiscal collection procedures in general by using a customized device which operates without the assistance of a person or institution to complete the transaction. The fundamentals of this invention is a broadening of the technological concept of automated vending, related elements of the automated tellers and/or interactive kiosks; accepting cash and or allowing the transfer of digital funds from the account of the credit or debit card holder to the final tax collector's account via the transaction facilitator which is this System for Digital Tax Vending.

### FIELD OF THE INVENTION

The present invention refers to the technology applications which facilitate the digital commercialization of goods and services through the use of an automated digital vending system; specifically a method and system that operates within the limits of the self-service mode. This comprises the absence of assistance to the system user from a physical person during the vending process or the consumer physical transportation to another location or institution to complete one single transaction. The vending process is performed in the end location where the consumer requires the final transaction, this means, without having to visit other intermediary institutions to complete the same transaction. This system and method accepts cash as payment in digital commercial transaction, as well as credit cards and debit cards, known as Identity Card Payments (PCI), No-Contact Payment Card (EMV) and/or encrypted point to point (PTS). The system uses a device which integrates elements similar to the Interactive Kiosks in an open platform for automated vending, allowing real time acceptance of payments for tax imprints, service fees and other government services which do not require personalized assistance and which digital vending provides a more expedited administration of judicial fees and other government services.

### BACKGROUND OF THE INVENTION

From 1950 to 1970 the first automated vending machines were coin operated and sold life insurance at airports, such machines are currently discontinued due to new technologies and changing market. The concept of self-service in retail begins in the banking industry with the combined effort of Japan, Sweden, United Kingdom and the United States. The first patent in this field U.S. Pat. No. 3,079,603 was filed on Jun. 30, 1960, and granted on Feb. 26, 1963, the inventor Luther George S. is entitled “Bankograph” claims a machine that accepts deposits in envelopes, accepts cash, checks and coins, emerging the first self-service system oriented to the Automated Teller Machines (ATM).

In the early 1960s several subsequent patents improved Luther George's initial patent, such as Patent No. GB1329964 submitted in September 1969 and granted in 1973 to several inventors including Jon E. Davis, claiming a machine that emits carbon copy checks in coded paper and a personal identification number PIN.

Note the concept of self-service had already been patented and initial protection of such early machines and inventions had expired, pluralizing the initial technology and providing an opportunity for new patents that extended the initial concept of self-service. In this sense, what was patented over the following years was new modality of devices with advanced technology and various new applications to solve emerging problems in the market.

In 1994 the concept expands to vending of food products. In recent decades from 2000 to 2010 a proliferation is recorded in the digital commercialization of products and services from transport tickets, tubes for bicycles in Germany and household products for retail in Japan. It is in Japan that acquires the Kiosk name and with each new model, a new patented granted for vending.

Kiosk evolves and accepts payments and makes sales of products and services. Unlike vending machines which only accept payment for the product sold. There are a variety of programs such as the recently known patent US20140149267 A1, whose inventor Leonard, A. obtained publication 29 May 2014 title “System and Methods for Providing a Vending Network” in which he claimed the some mechanisms for electronic funds transfer and the cash management program. This patent focuses on the inner workings of reconciliation of transactions improving some of the commonly known mechanisms since 1970 and adapted to the market of food products such as the vending of soft drinks deferring from the field of the present.

Some similarities can be identified between the present invention and the cited US20140149267A1 in the modalities for reception and registry of transaction payments between, priority dates of US20140149267A1 is Feb. 3, 2014, after the date of receipt of the present; the cited US20140149267A1 provides partial solutions to problems of a different market (the soft drinks markets).

With regard to the international classification G06Q30/0208 on marketing products and services using kiosks under the G06Q30/0237 classification; and the sub class G06Q30/0238 on marketing via point of sale (POS); and the G06F3/0488 sales class using the touch screen. In the prior art patent US20100251167A1, whose inventor is among several Lisa Deluca S., publication date Sep. 30, 2010, its known title “Scrolibar User Interface for Multitouch Devices” of, which claimed the use rotating menu bar on the touch screen for automated and/or payments for generalized sales. Today there has been an expansion in creative innovations, applications and uses of the original touch screens as a component of other devices, including cell phones and others. By itself the touch screen does not solve the problem the present invention seeks to satisfy.

From the bills to coins exchange machines, the automated vending machines dispensing hot and cold drinks, to more specialized systems with sensors such as the “I-Vending” which ensures greater accuracy in the exchange of bills during vending and other systems dispensing training products such as: DVDs, sporting goods, telecommunications and various products such as candy, cigarettes and snacks. In general, other subcategories related to the field of the present invention are G07F coin operated apparatus; G06L digital computers in which the computation is effected mechanically; Such it is the case of transport companies and mail handling, couriers in G07G1/100 classes, G07G5/00 machines issuing receipts and G07F17/26 machines used for printing among other.

With the diversification of identity payment cards and/or credit and debit card's encrypted readers, personal identification number pin (EPP), a new generation of payment systems and digital vending are created. Because the card reader is also commonly available outside the period of protection, magnetic stripe readers and other commonly used readers are incorporated today to digital vending. These components isolated or combined with the touch screen on any self-service device do not provide or suggest a complete or partial solution to our problem in question.

When the banking industry develops the secured encrypted processor, the magnetic strip to identify each customer and the use of (EPP4) in the “keyboard pads to insert personal identification codes” with the selection functions in the buttons or in the touch screens, from this combination of automated teller machines and kiosks arises the interactive stores. Up until now it has been applied and used for vending postage imprints, the transportation industry, telecommunications and other personal use items.

Exists in the Dominican Republic and in other countries the online payment system (POS), DOP2012000213 (A); US2013054468 (A1); Authors Federico Fuentes L, Ricardo A. Spain, entitled “System and Methods for Conducting Financial Transactions” which claims the internet and MXL, MB and CMS interfaces as the basis for payment transactions, using a point of sales system under the quality standard “ISO 8583”, it requires a bank account and use of a processor to perform the transaction. Such system relates strictly to the electronic payment process but does not solve the problem of the market segment the present invention resolves. This payment process relates to the partial transfer of financial information, unlike a full process of physical purchase where the transaction begins and ends in real time and there is a physical good or service exchanged at the end of the transaction. Furthermore, the user is limited when using the MXL, MB and CMS online payments, such process requires the user of the payment system on the network to have access to an Internet connection, a processor and once the payment is made, the user requires a printer to issue the receipt or payment proof which as proof of payment to present to a third party and location.

In regards to such method, due that not all users have easy access to an internet connection, a processor, a printer or bank account/card this online method significantly limits the scope that exists to satisfy the problem addressed herein, and as a method strictly for financial transaction processing, it does not in itself provide the solution to the problem the present inventions resolves; the online system also carries the risk of scammers that can interfere and divert funds or steal the identity and personal user data.

The present invention seeks to minimize these risks through a face transaction and allows real-time cash payment as a primary option and alternatively accepts payment by credit and debit cards. Other tax payments systems for example, also offer the ease of making payments through third-party institutions that report to the primary collector and charge a fee for services; Such is the case of payments made through local banks and/or financial institutions such as Western Union (in many other countries), then the funds are reported to the various primary entities receiving the final payment.

However, the present differentiates from that type of mode since the payment in that process does not occur in real time, the intermediary institution holds the funds for a period of time before releasing the funds to the final collector; also the location where the physical transaction takes place is not where the end user needs and receives the final product or service; whereas in the present system the user is in the location where he/she requires the final product or service. The user purchases and pays for the imprint or tax in this machine with cash via the vending platform and/or via card magnetic strip reader (PCI/EMV) or other suitable form of payment and completes the transaction receiving the seal, imprint tax or payment proof he/she requires without the need to stand in long lines or wait to go to third party intermediary institutions to receive personalized assistance; from the point of view of the primary tax collector, when the user pays using this self-service system, the tax funds are immediately debited from the account of the card holder and electronically deposited real time into the main collector's account.

Finally there are other modalities in the technological field in question. For example, in the US there is a system for selling postage; the service offers the ability to weight and measure your package and pay for the various levels of delivery, depending on whether the user prefers an express, priority or regular delivery mail.

It has a scale device which allows calculating the cost depending on the distance (similar to an integrated digital calculator). This service available worldwide via courier companies such as Federal Express (FedEx), United Postal Services (UPS), and others. This service differs from the present invention, in this system there is no measuring or weighing to calculate based on variables provided by the user. Furthermore, for the packages to be delivered to the final recipient of the package, such courier service (in the case of semi-automated postage services) will require the participation of other people, which excludes self-service mode subject of the present system. The present invention offers the user a number of options already pre-determined, standardized pre-programmed prices and the user simply chooses, buys and pays; the transaction is carried out from beginning to end without the intervention of other people rather than the user (self) and the device which receives and sends information; this method and digital vending system is designed specifically for the payment of court fees and all other taxes and fees imposed by the Government. It should also be noted that the semi-automated postage sales service in the United States, Europe and Asia has not expanded into their judicial system covered with this invention. Some of the factors influencing this, such judicial systems have some variances from the type of judicial system which initiated this machine in the priority country, different territories require adapted option selections for the user in compliance with the tax jurisdiction.

In the same manner, this system applies to such jurisdictions as the United States, as all other countries which specific needs allows the digitalized vending of most taxes. A required market study by jurisdiction for customized measurements of device's compartment permits dispensing all taxes and imprints as well as, customized of all available options in the menu.

This is in the same way that courier firms have made globally available their digital calculators and payment of postage services, as well as, transportation of passengers self-service ticket sales services have been made available worldwide by the transportation firms in the territories of United States, Europe, Asia, Africa, Middle East, Russia, Oceania, Australia, Latin America and the Caribbean. Their technology facilitates the purchase of transport tickets via the internet and via dispensers for ground transportation with debit and credit cards, which have been expanded to selling other items such as calling cards, concert tickets and other similar items however the simplicity of such process for vending such products and services could not be used in our device which provides a System for Digital Tax Vending (for judicial and all other government taxes).

The transportation ticket sales is very similar to the system used by courier services they both use the digital calculator, in the prior art referenced in BR7704199 (A)/ES406396 (A1) patent, the inventor is Aragall, P., dated Aug. 25, 1975, titled “Circuit for input of information given in parallel to a path in series, character by character in a digital electronic desktop calculator” which claimed the input mode in a digital calculator comparable to that used to determine the ticket price based on user-supplied variables of distance and/or time of use of the ticket; in other cases the tickets have pre-determined price. The System of the present invention does not allow the user to modify or provide variables as taxes payable are regulated and determined by the applicable law(s) of each country and for each specific record category. The present invention and system contains elements of a judicial nature that require knowledge of the workings of each country's judicial system for the digital vending to be implemented.

### DESCRIPTION OF THE INVENTION

The purpose of the present invention is to provide a System to expedite the collection of all applicable judicial imprints, governments' taxes and all other state, county, city dues related to fiscal tax collection procedures in general.

This system has been specifically created for a market segment which regularly uses the judicial system's services and products and performs other tax collection transactions.

The basis for our invention is concerned with expansion of the technological concept of the automated vending devices, elements of the ATMs and interactive kiosks, allowing cash handling and/or transfer of digital funds from the linked card or account used in the transaction to the main collector's account using this facilitator of the transaction, this method and System for Digital Tax Vending.

This device dispenses and issues judicial imprints, proof for paid service fees and other government taxes in the form of receipts and/or payment vouchers according to the category of payable taxes. The application and technology integration is specifically designed allow expedited collection of judicial and government taxes; this detailed integral and globalized mechanism for digital tax vending has not been offered up to this date in any other country in accordance with our independent, modest but thorough background research in the various international classes and sub classes previously mentioned, as well as their corresponding databases.

This System for Digital Tax Vending has been specifically considered to resolve a recurrent problem affecting users of having to wait in long lines for the payment of a court fee or government tax; with the use of this System such problem is resolved, eliminating the long wait lines of users waiting for personalized assistance which is the cause of the issue.

### System Components and Internal Characteristics

To achieve this self-service System, the device used is regulated by a program via a 32-bit ARM9 processor and 450 MIPS speed; It uses Windows as its operating system; a motherboard RAM and Flash memory of 8 MB by 16 MB which communicate with a printer simultaneously, a bills and coins reader, a card reader credit and debit; the type of reading is contactless and uses a touch screen. The developed model starts with a contactless reader. The readers can be adapted to any other type of card readers without affecting the System.

The System has been designed with preconceived technology updates by adjustments. For example, the present System includes expansion to other forms of payment such as a variety of digital currencies, also called crypto currencies and integrated wire transfers capabilities. In addition, the program in its advanced stage includes a downloadable application which the user can download to any personal computer, tablet, smartphone or other compatible equipment. We evaluate that some local economies are not ready for such advanced options therefore they are customized to each local economy and remain available to the user but options can be hidden from the main menu when fitting to such local economies.

This device requires network connectivity (online connectivity); It could be wired or wireless. There is one System prototype that accepts only cash, precluding the need for connectivity for payments. However attending to the needs of the population and technological trends the preferred prototype for this System is to accept credit/debit cards and digital payments; connectivity is useful to achieve the card verification, authorization and transfer of funds allowing the transaction to be completed in real time. The use of a dedicated line with a high-speed RS232 or alternately the highest speed resolution available; dedicated line being the most efficient and safest data transfer mode; the module requires a phone line or the use of a cellular signal for connectivity, it is also a possibility; the type of connection could be a USB master (maestro) and has modalities that support slave USB.

The source of energy used in the present System is external, about 12 volts-30 volts and contains an internal automated generator that can supply power internally up to 8 hours straight, to maintain its operation in the absence of external power. The internal components do not feed directly from the external energy source, instead, they are connected to the internal generator which in turn is connected to and being charged by the external power source, this also protects the components regulating voltages from possible fluctuations.

### Interior Compartments

This system contemplates device that store for vending tax documents and imprints in internal compartments. The compartments are designed to serve the country with their particular tax burdens, they can be adapted according to the needs of other countries; in regards to the compartments measurements, the System is designed for vending of all governments taxes, service fees and court imprints; in the territory of the Dominican Republic, it is included but not limited to Law 196 dated 1971; Law 91 dated 1983; Law 67 dated 1974; Law 80-99 dated 1999; Law 33-91 dated 1983; Law 370 dated 1968; Law 15-42 dated 1947; and all subsequent modifications that have been made or could be made. The model of our initial prototype contains compartments which serve these products measures: 1.5″ inches wide by 1.25″ height and 1 mm deep and 8.5″ inch wide by 11″ inches height by 1 mm deep and can adapted when necessary responding to demands of each institution. In the same manner some compartments have been adapted and designed to cover a variety of laws because its size allows it; these measurements are 4.02″ inches height by 5.5″ inches wide by 1 mm deep; and 9″ inches height by 5.5″ inches wide and 1 mm deep. These compartments can be adapted to other measurements when required, taking into account that new equipment will be manufactured with the modified measurements; the new measured compartment setting does not alters the overall functioning of the System.

### External Characteristics

The appearance and size can vary without affecting the functionality of the System. The physical structure is a combination of aluminum, steel and metal.

The overall dimensions of the equipment are 2′ feet 20″ height up 4′ feet depending on the model; 22.5″ to 26″ deep; 18.5″ to 24″ wide up to 1′ wide; over 25 kilograms of weight. There are slight variations between the model designs; the ergonomic aspects can be modified without affecting the overall System and method offered.

### Programming Mode Sample

Connected all devices: The bill and coins reader, card reader, printer, screen, processor board and the motherboard being properly installed and communicated by either wired mode or wireless means; programming prices and items via internal processor board. Access the main menu by pressing the mode button in the control panel. The following is an example of a standard price programming process. Considering that it is customized for each individual model.

Option 1 is pressed to see the different service options. The options will be displayed on the screen; press 3 to select the pricing module; in this step is that prices and items are set for vending using the keyboard. Select individual prices to assign the different prices for each product, press 3 to select the type of price, then 1 to increase the price on the screen or 2 to reduce it. Continue until all the items are clearly marked with its price and then press 3 to save the changes. Press 1 until an error appears and then to conclude press 3.

When the consumer selects an item, the electronic signal is delayed towards a rotating motorized handle via a dashboard, electronic console or processor, which rotates dispenser in spiral motion and down, touching the compartment of the selected item and the item falls and is dispensed. The machine charges the amount of cash or applies to the credit debit card using the card reader, which in turn is connected to the processor and sends the signal to the printer via the usb cable, which through proper connection receives the information and prints the receipt. In the case of taxes or service fees which are printed and are not dispensed, the main menu shows a more options sub menu allowing access to options to print a receipt with the amount, date, number and type of tax the user is paying. The paper used to print such receipt is an encrypted tamper-proof paper. Dispense mechanism is repeated, in this case, the motorized rotating handle is programmed to touch one of the compartments which permanently remains empty. The receipt prints the amount, date, number and tax concept.

### System Content and Menu Options

The System's main objective is to resolve and expedite the tax collection process in all the various state and government dependencies, such as the justice system as all other government taxes and service fees, for the purposes of make these collection process faster and more efficient, thus facilitating the transactions, eliminating long waiting lines at the various collection branches increasing the quality of service to citizens.

Another very useful aspect of this System is the simplification of administrative processes, as the program can generate and print reports; controls inventories, prices and maintenance issues remotely. The System can limit the number of imprints or service fees the user can buy and assigns a minimum order for some imprints.

The following imprints, taxes and service fees have been included in the present invention for digital vending and self-service; however the system has been designed to include all government taxes. These appear on the screen of the device as a menu of options; in the main menu, each category offers other options in turn as a submenu; categories initially relate to the territory of the Dominican Republic, noting that the names vary in other countries:

(1). Justice administration; (2). Passport; (3). Ground Transportation; (4). Interior and Police. (5). Mortgage conservatorship Civil Registry.

(1): In the Administration of Justice menu included all taxes, imprints and service fees which do not require personalized assistance, including but not limited to the following option. (1). Hearing Setting; (2). Obtain Certified Judgment; (3). Certification of Appeal; (4). Certification of No Appeal; (5). Conclusions payment; (6). Expanded Conclusions First Civil Chamber; (7). Expanded Conclusions for Civil Court of Appeal; (8). Legal Medical Certificate; (9). Form of Good Conduct; (10). Certified birth certificate; (11). Legalized Birth certificate; (12). Legalized Marriage Act; (13). Law 18-88 on luxury properties and vacant land; (14). Short term demand; (15). Referenced demand; (16). Referenced demand from hour to hour; (17). Filing of Cassation Memorial in the Supreme Court of Justice (Law 33-91); Law 80-99; R. Filing of Memorial of Cassation+Suspension Request, Memorial Defense (Civil, Land, Tax Litigation, Administrative Litigation); (18). Memorial Criminal Appeal Filing; Plea instance, suspension, expiration, lapsing, Designation of Judge, Exclusion, Review, Default; (19). Sentencing certification and/or Resolutions of the Supreme Court; Sub-categories Sentencing Certifications: (20). Criminal Record; (21). Jails Entry Permit; (22). Certification of Good Behavior issued by Mayors; (23). Certification of external and internal employment; (24). Lawyer Certification; (25). Travel banned certification; (26). Certification travel banned removal; (27). Certification for transfer of prisoners from a criminal jail to another; (28). Certification exequatur; (29). Permit temporary departure from prisons; (30). Notary certification; (31). Background certification for purposes of notary; (32). Certification status of a file; (33). Certification of notice; (3. 4). Certification prison inmate (death, release etc.); (35). Other certifications; (36). Certification of No Taxation of Property Jurisdiction. (37). Applications for no resources Certification.

(1): Within the passport dependence all taxes, imprints and service fees which do not require personalized assistance, including but not limited to the following options are included in the corresponding sub-menu: (1). Issuance of passports; (2). For 6 months; (3). For 2 years; (4). For 3 Years; (5). For 5 years; (6). Renewal of passports; (7). For 6 Months; (8). For 2 years; (9). For 3 Years; (10). For 5 years; (11). Duplicate due to Loss; (12). Duplicate due to damage. Within the ground transportation dependence taxes, imprints and service fees which do not require personalized assistance are included but not limited to the following options in the corresponding sub-menu: (1). Issuance of driver's license; (2). Driver License Renewal; (3). Duplicate for loss or damage. (4). Payment Penalty for Violation of Law 241; (5). Issue plate; (6) Renewal plate; (7). Payment for review/magazine; (8). Tax for Car Color Change; (9). Police Traffic Accident Act.

(1): Within dependence mortgage conservatorship and registry all taxes, imprints and service fees which do not require personalized assistance are included but not limited to the following options in the corresponding sub-menu: Sheriff Act Registration; (2). Registration of Promissory Notes; (3). Registration of Sales Contracts; (4). Registration of Will; (5). Registration of Grant; (6). Authentic Act Registration; (7). Registration of judgment.

(1): Within the dependence of interior and police all taxes, imprints and service fees which do not require personal assistance including but not limited to the following options in the corresponding sub-menu: (1). Permit Application Form Firearms; (2). Renewal Permit Firearm; Certifications: (3). Loss of ID; (4). Driver's license loss; (5). Vehicle Registration Loss; (6). Theft Complaints and Reports; (7). Good Behavior; (8). Lost Passport; (9). Copy Expedition on facts relating to the Homicide Investigation Department; (10). Discharges; (11). Retirement Pensions; (12). Complaints and Submissions; (13). Traffic Accident records; (14). Certified Copies Submissions (Pesquiza Act); (15). For Transfer Purposes; (16). Color change; (17). Issued for a lost plate; (18). Issued for lost registration; (19). For verification; (20). Chassis Number Correction; (21). Chassis number reprinting; (22). Chassis number change; (23). Changing Public license plate to private and vice versa; (24). Change Number of frontal due to accident; (24). Firearms Permit;

### BRIEF DESCRIPTION OF THE DRAWINGS

The System is shown more precisely in the detailed description of its components in the following section titled: detailed description of the drawings.

Drawing 1 is a diagram of the external design model 1 of the machine which accepts credit and debit cards payments and cash acceptance is optional with a wired connection.

Drawing 2 is a diagram of the inner workings of Drawing 1.

Drawing 3 is an external diagram of model 2 of the machine that accepts credit and debit card payments and cash with a wired connection.

Drawing 4 is a diagram of the inner workings of the system with cash handling, and some alternative options as using touch screen. The mechanism is enlarged on purpose in the drawing to show its performance.

Drawing 5 is an external diagram of design model 3 of the machine which accepts card payments and cash as an option and considers the possible elimination of physical imprints using that space for printing paper.

Drawing 6 is a diagram of the inner workings with wireless connection.

Drawing 7 is an embodiment of the System operations from to the user experience's perspective. Changes are permitted to customize and improve user's experience and/or as required for general improved customization per dependence service specifications

### DETAILED DESCRIPTION OF THE DRAWINGS AND THE SYSTEM'S COMPONENTS

Drawing 1 presents a touch screen (a) which communicates with the internal processor (Drawing 2) to display the menu options. Selection buttons (b) are used for choosing the desired tax, sending information indicating the required payment amount, which appears on the screen (a) presenting forms of payment options. Proceeding to process payments via card reader (c) or accepting cash via the bill validator (i) and coins (f) and returns cash change in the corresponding compartment (g); once inserted cash or card swiped, the internal processor (Drawing 2) connects with financial institution, verifies available funds and payment is processed; then sending the signal to the rotary robotic handle (Drawing 2) turning it in spiral and downwards and pressing triggering tax imprint compartment (h) releasing and dispenses the physical tax imprint in the retrieval compartment (e). The processor then sends the information to the printer (d) which prints the proof of payment in corresponding receipt. The cable (l) feeds electric power to the self-started automated generator which in turn provides electric power to all internal components; and the cable (k) provides the System with dedicated line connectivity.

Drawing 2 shows the internal mechanisms of the System for Digital Tax Vending. The screen (a) communicates with the processor (j) which in turn is communicated and connected to the motherboard or sensor's regulator (c) and in turn all previous components are connected to the electric self-started automated power generator (i). The processor (j) contains an integrated modem for dedicated connectivity. The processor (j) communicates with the printer (d) alerting when to print and it is also connected to the generator (i) which supplies power to all internal components. The compartment (h) is the compartment which dispenses tax imprints or service fees sold. This compartment has a gate (e) that opens and closes with each sale made to retrieve the tax imprints; it slides from the internal compartments (g) which stores and releases them triggered by a rotating robotic handle (f), which is activated once the tax imprint is paid. The card payment is made in unit (b) which is a card reader that processes credit and debit cards, accepting the payment and issuing a receipt in an encrypted technology tamper-proof paper. The cable (l) feeds with electric power the self-starter generator which in turn provides power to all internal components of the device (k) provides the System with dedicated line connectivity.

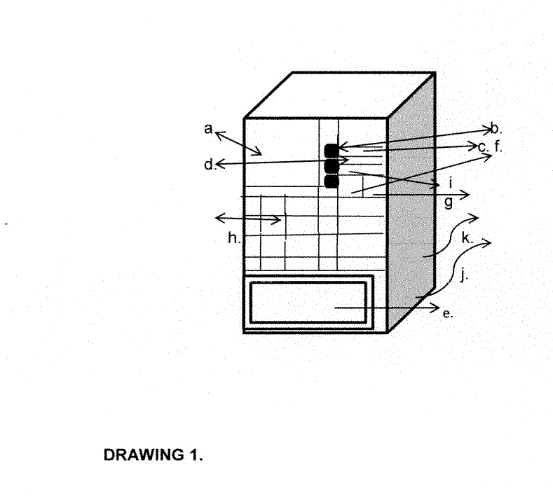

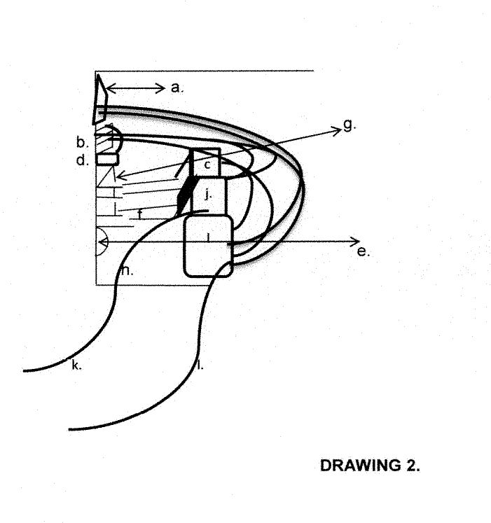

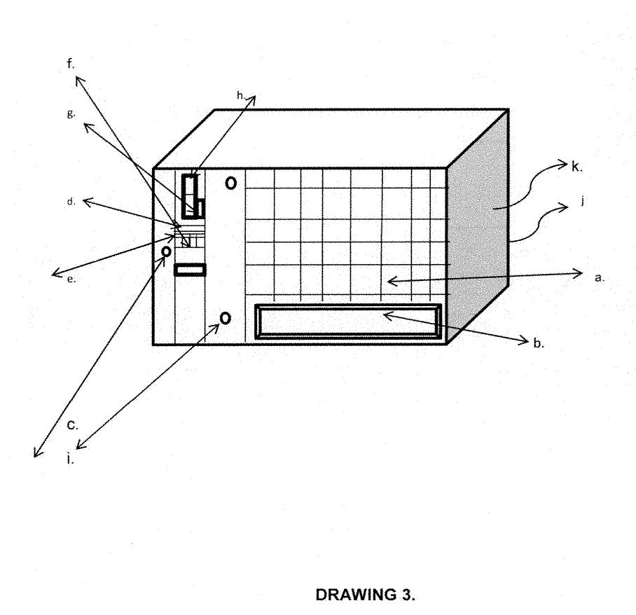

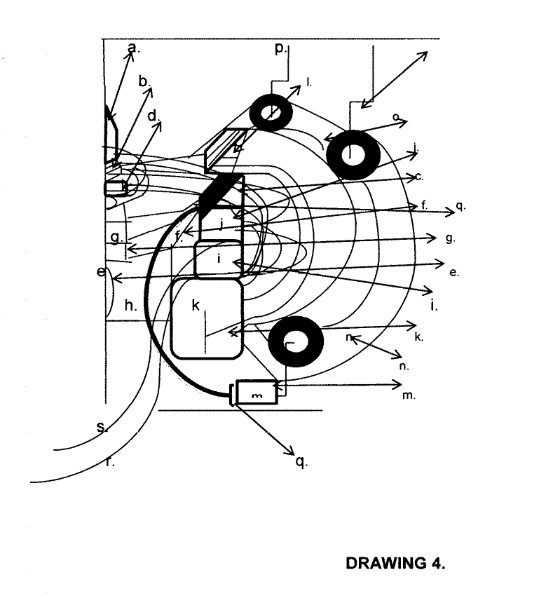

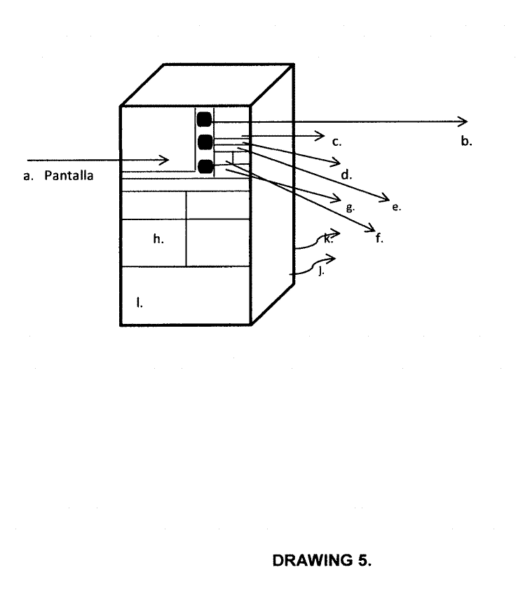

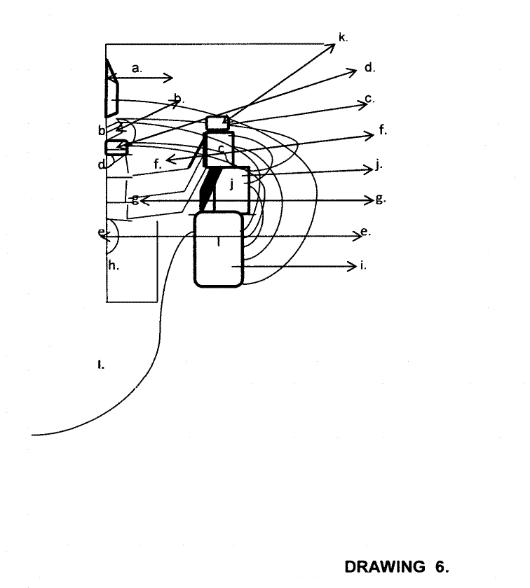

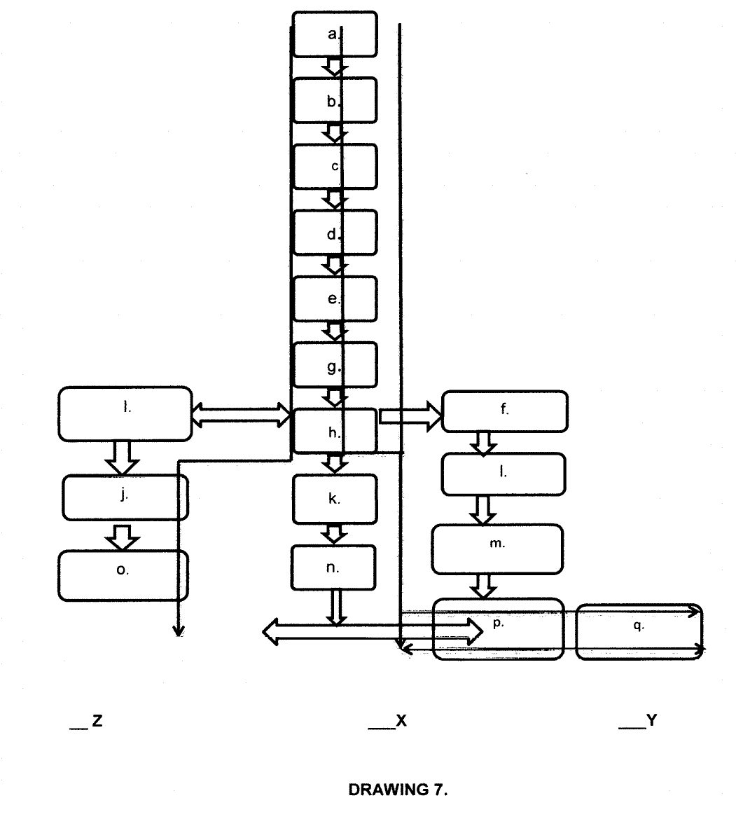

Drawing 3 shows the external design of an alternative model which includes the use of enlarged compartments (a) for tax imprints and these are released in the compartment (b) receipts are issued in the printer (e). The card reader (h) is located on the upper left side and a compartment for cash payment (d) and coins (g). The key board (f) contains codes for item selection of corresponding tax imprints or service fees which once pressed the rotating robotic handle (FIG. 2) triggers the compartment holding the tax imprint (b) where the selected item is released once the payment is processed. This model has a front gate (c) for inventory management, secured with a double glass gate reinforced by metal and a double lock (i). The cable (j) feeds with electric power the self-starter automated power generator which in turn supplies power to all internal components; the cable (k) provides the System with dedicated line connectivity.

Drawing 4 shows the mechanism for handling cash in addition to the mechanism as defined in Drawing 1. We note in this figure (intentionally enlarged to illustrate its operation) the communication between the screen (a); the card reader (b); the processor (j); the motherboard (c); the printer (d); generator (i); the compartments (g); the cavity to release imprints (h); the gate which opens to retrieve tax imprints (e). The card reader, remains as explained in Drawing 1. It is added to this diagram the bills and coins reader (l); which activates the internal rotatory handle comprising: wheels (o) in motion due to a rotating belt (n) that transports the bills to a vault (k) internal security. The belt rotates once activated by a motor (m) to transfer the cash payment to the vault (k) for safe storage. This mechanism is activated by sensors (q) Internally mutually communicated, the motor (m) which activates and moves the belt (n), once cash is inserted; and deactivated in the absence of weight once the cash transported is released. The belt is held in by hooks (p) at different points along the route. The cable (r) feeds with electric power the self-starter automated power generator (i) which in turn supplies energy to all internal components; and the cable (s) provides the System processor with dedicated line connectivity.

Drawing 5 is a variation of the external ergonomic design of Drawings 1 and 3 considers the exclusion of physical tax imprints and uses the compartments devoted for such imprints (h) with space for printing paper. In this model, vending of taxes or service fees occurs when the printer (d) issues the receipt once the payment is processed and the receipt serves as proof of payment which can be presented to the institution requiring such proof of payment. The communication between the screen (a); selection buttons (b), the printer (d) and the card reader (c) bills reader (e), coins reader (f) compartment for return of change (g), cavity to remove the tax imprints (l); as well as all internal mechanisms previously defined in Drawings 2 and 4 remain unmodified. Only added to this external diagram are compartments for paper (h) for the purpose of issuing tax imprints payment proof once the payment is processed. The selection buttons in this model (b) are to the right; as well as, openings for acceptance of coins (f) and the return of change (g) also right. The cable (j) feeds electric power to the self-starter automated power generator (i) which in turn feeds energy to all internal components; cable (k) connects the System processor with dedicated line connectivity (Drawings 2, 4, and 6).

Drawing 6 shows an internal performance diagram of the System for Digital Tax Vending using wireless technology, precludes cash and or cash back features. This model only accepts electronic payments e.g. credit and or debit cards for greater service speed and efficiency. All elements are clearly defined and explained in the inner workings detailed in Drawings 2 and 4; cash handling is replaced with mechanisms for wireless communication technology. The screen (a), the card reader (b), the motherboard or moderator of sensors (c), the processor (j) and printer (d) communicate by wired means. However the modem (k) communicates with the outside wirelessly. The robotic rotatory handle (f) releases the imprint or service fee receipt once the payment is completed (d) issuing proof or receipt under processor orders (j); to dispense tax imprints or service fees for sale (g) there is a gate (e) that opens and closes a compartment (h) to retrieve the tax imprints sold. The cable (l) feeds electric power and perpetually recharges the generator (i) which in turn feeds energy all internal components. Connectivity cable is removed.

Drawing 7 is an example of embodiment. It shows the process and operation of the system from the user's perspective. The experience initiates (a) once the user comes to the screen, the system will ask what type of purchase does the user intends to complete (b). Then the user will make a selection from the main menu (c) once the user has made his selection, is asked what kind of payment it is preferred (d) proceedings next to step either card payment (e) credit/debit; or in alternative to cash payment (f); then proceeding to swipe the credit or debit card (g) and validation of funds (h) if the card funds are validated (k) the transaction is successful (n). When paying cash (l), the consumer receives change (m) dispensing the tax imprints (p) issuing the receipt (q). If the card is invalid (i) the transaction displays a transaction canceled message (j), exiting the system (o). The center line in the diagram (x) shows the path of a successful transaction using cash; the right line (y) shows the consumer experience in a successful transaction using a credit/debit card; the left line (z) shows a canceled transaction.

1. System for Digital Tax Vending embodies a system permitting the digitalized, automated and regionalized vending of all government taxes, judicial imprints and all state governmental service fees which do not require personalized assistance in an integrated and customized platform for each and all countries and herein comprising the following method:

2. Method of claim 1 wherein the system user pays a service provider for the digital vending of judicial taxes, imprints, service fees and other state governmental taxes required by the system user, such payment characterized by the system user's performing of the transaction where the user requires the final transaction, which is accomplished in a face and in real time form. This step excludes online payments, post-paid and or via PDA's, personal computers.

3. Method of claim 1 wherein the digital vending transaction (s) in question is carried out using a device characterized by accepting multiple forms of payments in the local currency where the system is installed and compatible with the local financial system; requiring DSL connectivity or such of superior security.

4. Method of claim 1 wherein the system's device is characterized by integrating multiple interactive vending points and open modules platform into an automated self-service vending protocol;

5. Method of claim 1 wherein a digital vending of government taxes, governmental services, judicial tax imprints and service fees is embodied using a device characterized by the physical display of imprints available for vending in compartments specifically designed for these items, as for taxes and other fees;

6. Method of claim 1 wherein the system's device is characterized by having and presenting a menu of options customized by country and displayed to the system user on a touch screen with digital and or physical selection buttons; the system user can also access and navigate the menu options connecting via downloadable application (AP) to the system user's preferred and compatible device or equipment for such payments which do not require physical payment proof. This (AP) allows the use of the system however it does not sells the system (itself) nor other programs.

7. Method of claim 1 wherein the system user selects the tax imprint or required service fee from the system's menu by using a combination of buttons and keyboards physical or virtual without the assistance of another person or institution to complete the vending process;

8. Method of claim 1 wherein the payment associated with selected option during the digital vending of such taxes is done by either accepting cash payment or the verification of credentials of the system user and availability of funds via an internal processor which performs the data transport and the transfer of funds in a real time face transaction.

9. Method of claim 1 wherein the no contact transfer of information (PCI) occurs connecting to a server via wired means, also considering wireless means of connectivity depending on the device modality used, and the service provider, as the location of the system, user data and payment method selected by the system user.

10. Method of claim 1 wherein the transfer of user's card data and by the means specified in the preceding claim 9, allows this data transfer process to be characterized by a unique funds authorization record for each individual transaction by using one or more identifiers for validation;

11. Method of claim 1 wherein the payment contact credentials, where personal identification number (PIN) is required, the present method is characterized by allowing PIN validation before sending payment credentials, authorizing funds for the tax or service fee vended.

12. Method of claim 1 wherein the system user when electing credit or debit card as a form of payment, and once issued the funds authorization, such method is characterized by such authorization being transmitted by electronic and or virtual means, which once received by this system, an authorization triggers the activation of internal sensors releasing the tax imprint, service fee or other tax print receipts;

13. Method of claim 1 wherein a system user is permitted the option of electing cash as a form of payment for the required tax imprints, services fees or other desired government taxes without being assisted by another person or intermediary institution to complete the desired transaction;

14. Method of claim 1 and in accordance with the previous claim 13, this present system is characterized by having the capability for accepting cash via using a bill and coins reader which scans, identifies, counts and stores bills and coins then communicates internally with the sensors which release the desired item, connecting simultaneously to the printer and issuing the payment receipt for the corresponding service fee or tax paid.
